(19) United States
(12) Patent Application Publication
(10) Pub. No.: US 2013/0037175 A1
(43) Pub. Date: Feb. 14, 2013

(54) PREPARATION OF ITACONIC ACID HOMO- OR COPOLYMERS AND AMINE- OR AMIDE- CONTAINING ALCOHOLS FOR METAL SURFACE TREATMENT

(71) Applicants: Friederike Fleischhaker, Ludwigshafen (DE); Christian Schade, Ludwigshafen (DE); Anna Müller-Cristadoro, Heppenheim (DE)

(72) Inventors: Friederike Fleischhaker, Ludwigshafen (DE); Christian Schade, Ludwigshafen (DE); Anna Müller-Cristadoro, Heppenheim (DE)

(73) Assignee: BASF SE, Ludwigshafen (DE)

(21) Appl. No.: 13/551,127

(22) Filed: Jul. 17, 2012

Related U.S. Application Data
(60) Provisional application No. 61/521,775, filed on Aug. 10, 2011.

(51) Int. Cl. C23C 22/06; B32B 15/00

(52) U.S. Cl. 148/251; 148/22; 148/400

(57) ABSTRACT

The present invention relates to an aqueous preparation for passivating metallic surfaces, comprising itaconic acid homopolymers or copolymers and at least one amine- or amide-containing alcohol, to a method for passivating metallic surfaces by treating the surface with the preparation of the invention, to passivating layers and metallic surfaces obtainable by means of the method of the invention, and to the use of the preparation of the invention for passivating a metal surface.

The present invention relates to a preparation for passivating metallic surfaces, comprising itaconic acid homopolymers or copolymers and amine- or amide-containing alcohols, to a method for passivating metallic surfaces by treating the surface with the preparation of the invention, to passivating layers and metallic surfaces obtainable by means of the method of the invention, and also to the use of the preparation of the invention for passivating a metal surface, more particularly in the pretreatment of strip metals.

The raw material used for the production of sheetlike metallic workpieces such as, for example, white goods, equipment linings, facade claddings, ceiling claddings or window profiles, automotive components, and bodywork components is presently, typically, long metal strips which are produced by hot rolling and/or cold rolling of metal blocks, or “slabs”, and which are wound into coils for the purposes of storage and transportation.

The metal strips are divided up and are shaped to form the desired components by means of suitable techniques such as punching, drilling, folding, conversion into profiles and/or deep drawing. Larger components, such as automobile bodies, for example, are joined, optionally, by welding a plurality of individual parts together.

The corrosion protection treatment of metallic materials of this kind is typically accomplished in multistage operations, and the surface of treated metals has a plurality of different layers. A corrosion protection treatment can be performed at various points in the production operation. The corrosion protection involved may be either temporary or permanent. Temporary protection is applied, for example, only for storage or transportation of a metal strip or other metallic workpiece, and is removed again prior to ultimate processing.

Corrosion protection layers which are applied to metal strips that are subsequently to be shaped to form components are required to have not only the pure corrosion protection effect but also good mechanical properties as well. The corrosion protection layers are required in particular to have sufficient capacity for elongation, so that they do not rupture on forming, which otherwise would mean that there would no longer be any sufficient corrosion protection at such locations.

Protecting metallic components from corrosion is of great economic importance. Of particular technical economic importance in particular is the corrosion protection treatment of aluminum surfaces and also of the surfaces of galvanized metals, more particularly electrogalvanized or hot dip galvanized iron or steel. The corrosion protection of the zinc derives from the fact that it is less noble than the metallic material itself, and therefore initially undergoes corrosion itself. The metallic material per se remains intact as long as it is still continuously covered with zinc.

In the presence of atmospheric oxygen, a thin oxide layer forms initially on the surface of Zn or Zn alloys, Al or Al alloys, and to a greater or lesser extent retards the corrosive attack on the underlying metal, depending on the external conditions.

In order to boost the protective effect of an oxide layer of this kind surfaces of Al and Zn are generally subjected to an additional passivating treatment. In the course of such a treatment, at least some of the metal/metal oxide to be protected is dissolved in the form of metal irons, which are then incorporated into the passivating layer applied. This film resembles the oxide film which is present in any case, but it affords greater protection. It is commonly referred to as a passivating layer. In many cases it also enhances the adhesion of paint coats applied to the metal. Instead of the term “passivating layer”, therefore, the term “conversion coat” is often used synonymously, and sometimes also the term “pretreatment layer”. Passivating layers are comparatively thin and typically have a thickness of not more than 3 μm.

In order to reinforce the corrosion protection, additional (paint) layers are generally applied to the passivating layer. Such systems usually comprise a combination of two or more paint layers, each serving different purposes. They serve to protect the passivating layer and the metal from corrosive gases and/or liquids, but also from mechanical damage, such as stone chipping, for example, and also serve for esthetic purposes as well, of course. Paint layers are typically much thicker than passivating layers. Typical thicknesses range from 2 μm to 400 μm.

Passivating may be used for permanent or else only temporary corrosion protection. Temporary protection is used only for the storage or transportation of a metal panel or other metallic workpiece, and is removed again prior to ultimate processing.

Passivating layers on zinc or aluminum surfaces have generally been obtained to date by treating the workpiece requiring protection with aqueous, acidic solutions of CrO₃. The mechanism of such passivation is complex. It includes the dissolution of metallic Zn or Al from the surface, and its reprecipitation in the form of amorphous zinc-chromium oxides or aluminum-chromium oxides, respectively. The layers, however, may also comprise extraneous ions and/or further components from the treatment solution. In the case of treatment with chromic acid, in particular, it is impossible to rule out the incorporation into the passivating layer of a certain fraction of Cr(VI).

In order to avoid treatment with carcinogenic Cr(VI) solutions, proposals have been made to treat the metallic surfaces with acidic aqueous Cr(III) solutions. Reference may be made, for example, to U.S. Pat. No. 4,384,902. Increasingly, though, there are customers on the market who require entirely chromium-free passivating processes. For avoiding the use of Cr(VI) and Cr(III), therefore, the use of polymers is gaining importance increasingly.

DE-A 195 16 765 discloses a chromium-free and fluoride-free process for producing conversion coats on metallic surfaces of Zn or Al. The acidic solution used for passivating comprises a water-soluble polymer, phosphoric acid, and Al chelate complexes. It is additionally possible, optionally, to use polymers and copolymers of (meth)acrylic acid.

DE-A 197 54 108 discloses a chromium-free, aqueous corrosion protection composition which, however, comprises toxic hexafluoro anions of Ti(IV) and/or Zr(IV), vanadium ions, cobalt ions, and phosphoric acid. As an option it is also possible, furthermore, to add various film-forming polymers, including carboxyl-containing copolymers such as acrylic acid/maleic acid copolymers.

WO 2004/074372 A1 relates to an acidic aqueous preparation for passivating metal surfaces, comprising copolymers of 50% to 99.9% by weight (meth)acrylic acid and 0.1% to 50% by weight acidic comonomers, such as, for example, ethylenically unsaturated dicarboxylic acids, and/or polymerizable phosphoric and/or phosphonic acids. Itaconic acid is among the possible dicarboxylic acids. The composition may comprise tertiary alkaline amines, preferably hydroxylamines such as mono-, di-, and triethanolamine. Other amine-containing alcohols are not mentioned. The addition of hydroxylamines is mentioned in general, and demonstrated specifically only for a copolymer of acrylic acid and maleic anhydride, but not for the combination according to the invention.

WO 2006/021309 A1 discloses a method for passivating metallic surfaces using an acidic aqueous preparation comprising itaconic acid homopolymers or copolymers. The itaconic acid polymers are prepared at a polymerization temperature of less than 120° C., producing better corrosion protection in relation to acrylic acid-maleic acid copolymers. Preparations of these itaconic acid homopolymers or copolymers comprising alcohol amines are not described.

The above-described preparations are still in need of improvement in terms of corrosion protection, particularly in relation to the passivation of strip metals (coil coating).

It is an object of the invention to provide an improved preparation for passivating metallic surfaces that can be employed with particular advantage for the pretreatment of strip metals. The preparation in question preferably ought to be aqueous and to be free from chromium and from fluoride.

The invention provides a preparation for passivating metallic surfaces, comprising
a) at least one itaconic acid homopolymer or copolymer (A), the polymer being synthesized from the following monomeric units:
   (a1) 0.1% to 100% by weight of itaconic acid,
   (a2) 0% to 99.9% by weight of at least one monoethylenically unsaturated monocarboxylic acid, and
   (a3) 0% to 40% by weight of at least one further ethylenically unsaturated monomer, which is different from (a1) and (a2) and contains acidic groups, and/or
   (a4) 0% to 75% by weight of at least one further ethylenically unsaturated monomer, which is different from (a1), (a2) and (a3),
   the amount being based in each case on the total amount of all the monomers copolymerized in the copolymer;
b) water or another solvent suitable for dissolving, dispersing, suspending or emulsifying polymer (A), as component (B); and
c) at least one amine- or amide-containing alcohol (C),
   with the exception of preparations comprising at least one copolymer (A) of (a1) 0.1% to 50% by weight itaconic acid and (a2) 50% to 99.9% by weight (meth)acrylic acid, component (B), and mono-, di- and/or triethanolamine as component (C).

The invention further provides a method for passivating metallic surfaces using the preparation of the invention. The invention additionally relates to a passivating layer on a metallic surface, obtainable by the method, and also to metallic surfaces comprising such a passivating layer.

Surprisingly it has been found that metal surfaces treated with the preparation of the invention are significantly more resistant toward corrosion than those in accordance with the prior art. The passivation of the metal surfaces, especially in the pretreatment area, is significantly improved.

### DETAILS OF THE INVENTION NOW FOLLOW

The itaconic acid homopolymers or copolymers (A) that are used in the preparation of the invention are soluble or at least dispersible in water or in aqueous solvent mixtures with a water content of at least 50% by weight, the skilled person being aware that the solubility of COOH-rich polymers can be heavily pH-dependent. Reference is therefore made here to the pH levels at which the polymers are used for passivation, in other words to an acidic solution, and more particularly to the pH range from 0.5 to 6. The term “water-dispersible” means that the solution is not entirely clear, but the polymer is homogeneously distributed therein and does not undergo a sedimentation either. The polymers used ought preferably to be infinitely miscible with water, although this is not absolutely necessary in every case. It must, however, be water-soluble at least to an extent such that passivation by means of the preparation of the invention is possible. As a general rule, the polymers used ought to have a solubility of at least 50 g/l, preferably 100 g/l, and more preferably at least 200 g/l.

The polymers in question are preferably water-soluble.

The monomer (a1) for preparing the homopolymer or copolymer used in accordance with the invention is itatonic acid:

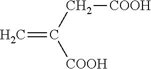

The itaconic acid can also be used in the form of its salts, such as an alkali metal salt or ammonium salt, for example. It is also possible, moreover, to use derivatives of itaconic acid that readily undergo hydrolysis to itaconic acid in aqueous solution, such as, for example, the corresponding anhydride, monoesters or diesters, or acid amides. It will be appreciated that mixtures of such derivatives can be used as well.

The polymer used in accordance with the invention may be a homopolymer or, preferably, a copolymer of itaconic acid.

The amount of itaconic acid in the polymers is 0.1% to 100% by weight, preferably 10% to 70% by weight, more preferably 15% to 65% by weight, very preferably 20% to 50% by weight, more particularly 25% to 45% by weight, this figure being based on the sum of all the monomers in the polymer.

The polymer used in accordance with the invention may further comprise up to 99.9% by weight of one or more monomers (a2). These are monoethylenically unsaturated monocarboxylic acids.

Examples of suitable monoethylenically unsaturated monocarboxylic acids (a2) include acrylic acid, methacrylic acid, crotonic acid, vinylacetic acid or else C₁-C₄ monoesters of monoethylenically unsaturated dicarboxylic acids. Acrylic acid and methacrylic acid are preferred, acrylic acid particularly preferred.

It will be appreciated that mixtures of two or more different monoethylenically unsaturated monomer carboxylic acids can also be used.

The amount of all monomers (a2) together is preferably 30% to 90% by weight, more preferably 30% to 70% by weight, very preferably 35% to 65% by weight.

The copolymer used in accordance with the invention may optionally further comprise 0% to 40% by weight of at least one further—different from (a1) and (a2)—ethylenically unsaturated monomer (a3). The monomers (a3) each have at least one acidic group. With particular preference they are each monoethylenic monomers. The monomers (a3) are radically polymerizable.

The monomers (a3) may be, for example, carboxyl-containing monomers (a31), monomers (a32) comprising phosphoric acid groups and/or phosphonic acid groups, or monomers (a33) comprising sulfonic acid groups.

The monomers (a3) may also be used in the form of their salts, such as alkali metal salts or ammonium salts, for example. Moreover, it is also possible to employ those derivatives of the monomers (a3) which readily undergo hydrolysis to the free acids in aqueous solution, such as, for example, anhydrides, monoesters or diesters, or acid amides. It will be appreciated that mixtures of such derivatives can be used as well.

Examples of carboxylic-containing monomers (a31) include, in particular, ethylenically unsaturated dicarboxylic acids such as, for example, maleic acid, mesaconic acid, citraconic acid, fumaric acid or methylenemalonic acid. A preferred monomer (a31) is maleic acid or maleic anhydride.

Examples of suitable monomers (a32) include vinylphosphonic acid, monovinyl phosphate, allylphosphonic acid, monoallyl phosphate, 3-butenylphosphonic acid, mono-3-butenyl phosphate, mono(4-vinyloxybutyl)phosphate, phosphonoxyethyl acrylate, phosphonoxyethyl methacrylate, mono(2-hydroxy-3-vinyloxypropyl) phosphate, mono(1-phosphonoxymethyl-2-vinyloxyethyl)phosphate, mono(3-allyloxy-2-hydroxypropyl)phosphate, mono-2-(allylox-1-phosphonoxymethylethyl)phosphate, 2-hydroxy-4-vinyloxymethyl-1,3,2-dioxaphosphole, 2-hydroxy-4-allyloxymethyl-1,3,2-dioxaphosphole, and 2-methacrylamidoethylphosphoric acid. It is also possible to use salts and/or esters, more particularly C₁-C₈ monoalkyl, dialkyl, and optionally trialkyl esters of monomers containing phosphoric acid and/or phosphonic acid groups.

A preferred monomer (a32) is vinylphosphonic acid or hydrolysable esters thereof.

Examples of monomers (a33) containing sulfonic acid groups include allylsulfonic acid, methallylsulfonic acid, styrenesulfonate, vinylsulfonic acid, allyloxybenzenesulfonic acid or 2-acrylamido-2-methylpropanesulfonic acid, 2-(methacryloyl)ethylsulfonic acid, and the alkali metal salts thereof.

It will be appreciated that mixtures of two or more different monomers (a3) may also be used. Preference is given to monomers (a31) comprising carboxyl groups, and to monomers (a32) comprising phosphoric acid groups and/or phosphonic acid groups. Particularly preferred among the monomers (a3) are monomers (a32) comprising phosphonic acid groups, more particularly vinylphosphonic acid and/or hydrolysable esters thereof.

If monomers (a3) are present, their amount together is preferably 0.1% to 40% by weight, more preferably 1% to 35% by weight, and very preferably 5% to 25% by weight.

Furthermore, the copolymer may optionally further comprise 0% to 30% by weight of at least one further—different from (a1), (a2), and (a3)—radically polymerizable, ethylenically unsaturated monomer (a4). Over and above these, no other monomers are used.

The monomers (a4) serve to fine-tune the properties of the copolymer. They are selected by the skilled person in accordance with the desired properties for the copolymer. They are preferably likewise monoethylenically unsaturated monomers. In special cases, however, small amounts of monomers having two or more polymerizable groups may also be used. In this way the copolymer can be crosslinked to a slight extent.

Examples of monomers (a4) include C₁-C₈ alkyl esters or C₁-C₄ hydroxyalkyl esters of (meth)acrylic acid, such as methyl (meth)acrylate, ethyl (meth)acrylate, propyl (meth)acrylate, isopropyl (meth)acrylate, butyl (meth)acrylate, hexyl (meth)acrylate, 2-ethylhexyl (meth)acrylate, hydroxyethyl (meth)acrylate, hydroxypropyl (meth)acrylate or butane-1,4-diol monoacrylate. The alcohol components in the (meth)acrylic esters may also be alkoxylated alcohols. Here mention may be made more particularly of alkoxylated C₁-C₁₈ alcohols which have 2 to 80 mol of ethylene oxide, propylene oxide, butylene oxide or mixtures thereof. Examples of alkoxylated products of this kind include methylpolyglycol (meth)acrylate or (meth)acrylic esters of C₁₃/C₁₅ oxo-process alcohol reacted with 3, 5, 7, 10 or 30 mol of ethylene oxide, and mixtures of such products, and also (methyl)styrene, maleimide, N-alkylmaleimide, maleic monoamides or maleic monoesters.

Additionally suitable are vinyl ethers or allyl ethers such as, for example, methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether or methyldiglycol vinyl ether, and the corresponding allyl compounds. It is likewise possible to use vinyl esters such as vinyl acetate or vinyl propionate, for example.

Examples of basic monomers include acrylamides, which optionally may be substituted, for example, by alkyl or hydroxyalkyl, such as, for example, acrylamide, methacrylamide, N-tert-butylacrylamide or N-methyl(meth)acrylamide. It is additionally possible to use basic monomers such as 1-vinylimidazole and N-vinylpyrrolidone as well.

Examples of crosslinking monomers include molecules having two or more ethylenically unsaturated groups, examples being di(meth)acrylates such as ethylene glycol di(meth)acrylate or butane-1,4-diol di(meth)acrylate, or poly(meth)acrylates such as trimethylolpropane tri(meth)acrylate, or else di(meth)acrylates of oligoalkylene or polyalkylene glycols such as di-, tri- or tetraethylene glycol di(meth)acrylate. Further examples include vinyl (meth)acrylate, allyl (meth)acrylate, divinylethyleneurea or butanediol divinyl ether. Likewise suitable are di- and oligo-allyl ethers of polyhydroxy compounds, such as pentaerythritol triallyl or tetraallyl ether, for example.

It will be appreciated that a mixture of different monomers (a4) may also be used. The amount of all the monomers (a4) used, together, is 0% to 75% by weight, based on the total amount of all the monomers used for the method. The amount is preferably 0% to 50% by weight, more preferably 0% to 15%, and very preferably 0% to 10% by weight. If crosslinking monomers (a4) are present, their amount, as a general rule, ought not to exceed 5%, preferably 2% by weight, based on the total amount of all the monomers used for the method. The amount may be, for example, 10 ppm to 1% by weight.

The skilled person selects the nature and amount of the monomers used in accordance with the desired passivation. In doing so, he or she will take account of the fact that the polymer is to be water-soluble or water-dispersible. Monomers which might detract from the water-solubility of the polymer will therefore be used by the skilled person only in amounts such that no adverse effects can occur.

Preference is given to copolymers of itaconic acid and acrylic acid, more preferably copolymers of 35% to 65% by weight itaconic acid and 35% to 65% by weight acrylic acid, very preferably 40% to 60% by weight itatonic acid and 40% to 60% by weight acrylic acid, and more particularly 51% to 60% by weight itaconic acid and 40% to 49% by weight acrylic acid.

Additionally preferred are terpolymers of itaconic acid, acrylic acid, and vinylphosphonic acid, more preferably of 20% to 50% by weight itaconic acid, 30% to 50% by weight acrylic acid, and 1% to 30% by weight vinylphosphonic acid, more particularly 35% to 45% by weight itaconic acid, 40% to 50% by weight acrylic acid, and 5% to 25% by weight vinylphosphonic acid.

The monomers used are polymerized radically in aqueous solution.

The term “aqueous” implies that the solvent or diluent used has water as its principal constituent. Besides water, however, there may also be fractions present of organic solvents that are miscible with water. This may be necessary, for example, in order to improve the solubility of certain monomers, particularly the monomers (a4), in the reaction medium.

The solvent or diluent used, accordingly, contains at least 50% by weight of water, based on the total amount of the solvent. In addition there may be one or more water-miscible solvents used. Mention here may be made in particular of alcohols, examples being monoalcohols such as ethanol, propanol or isopropanol, dialcohols such as glycol, diethylene glycol or polyalkylene glycols, or derivatives thereof. Preferred alcohols are propanol and isopropanol. The water fraction is preferably at least 70% by weight, more preferably at least 80% by weight, very preferably at least 90% by weight. It is especially preferred to use water exclusively.

The implementation of the radical polymerization is known in principle to the skilled person. One preferred preparation process for itaconic acid homopolymers or copolymers used in accordance with the invention is disclosed in WO 2006/021309, hereby incorporated by reference.

According to one preferred embodiment, the polymerization of the monomers (a1) to (a4) used in accordance with the invention is performed at a temperature of less than 120° C. Apart from this, the temperature may be varied by the skilled person within wide limits, depending on the nature of the monomers used, the initiator, and the desired outcome. It has been found appropriate here to use a minimum temperature of about 60° C. During the polymerization the temperature may be held constant, or else temperature profiles may be operated. The polymerization temperature is preferably 75 to 115° C., more preferably 80 to 110° C., with particular preference 90 to 108° C., and very preferably 95 to 105° C.

Preparations of the invention comprising itaconic acid homopolymers or copolymers (A) obtained by radical polymerization in aqueous solution at a temperature of less than 120° C. are particularly preferred.

The polymerization can be performed in customary apparatus for radical polymerization. When operating at above the boiling temperature of water or of the mixture of water and further solvents, operation takes place in a suitable pressure-rated vessel; otherwise, unpressurized operation is possible. The polymerization is preferably performed unpressurized. Polymerization may be carried out under reflux, for example.

With regard to the polymerization it has been found generally appropriate to introduce, first of all, itaconic acid (a1) and/or derivatives thereof in aqueous solution. Thereafter it is possible to meter in the monocarboxylic acid (a2) and also the initiator, usefully likewise in aqueous solution. Feed times of 0.5 h to 24 h, preferably 1 h to 12 h, have been found appropriate.

In this way, the concentration of the more highly reactive monocarboxylic acids (a2) in the aqueous solution is kept relatively low. This reduces the tendency for reaction of the monocarboxylic acid with itself, and a more uniform incorporation of the itaconic acid units into the copolymer is achieved. If optionally used monomers (a3) and/or (a4) are slow to react, it is likewise advisable to introduce them at the start together with the itaconic acid. It will be appreciated, though, that they may also be added dropwise later on. After all of the monomers have been fed in, there may be a subsequent reaction time, of 0.5 to 3 h, for example. This ensures that the polymerization reaction proceeds as completely as possible.

The skilled person, however, may of course also perform the polymerization in a different way.

The polymers synthesized may be isolated from the aqueous solution by means of customary techniques known to the skilled person, as for example by evaporating the solution, spray drying, freeze drying or precipitating.

Of particular preference, however, the polymers are not isolated from the aqueous solution at all after the polymerization; instead, the polymer solutions are used as they are for the preparation of the invention, and are optionally diluted.

The molecular weight M_{w} (weight average) of the itaconic acid homopolymers or copolymers used in accordance with the invention is 5000 to 2 000 000 g/mol, preferably at least 10 000 g/mol, more preferably at least 15 000 g/mol. As a general rule, M_{w} is 15 000 g/mol to 200 000 g/mol, preferably 20 000 g/mol to 100 000 g/mol, more preferably 30 000 g/mol to 80 000 g/mol. The weight is specified by the skilled person in accordance with the desired end use.

Component (B) of the preparation of the invention is water or another solvent capable of dissolving or dispersing, suspending or emulsifying the itaconic acid homopolymer or copolymer (component A). A solvent in the context of the present text means a liquid matrix in which the various ingredients of the preparation of the invention are present in an extremely finely divided form. Fine division of this kind may be for example, in the sense of a molecularly disperse distribution, a true solution of the ingredients in the solvent. The term “solvent”, however, also encompasses liquid matrices in which the ingredients are distributed in the sense of an emulsion or dispersion, i.e., do not form a molecularly disperse solution. Preference is given to a clear solution and also to water as solvent.

Examples of suitable solvents include water and also water-miscible and water-immiscible solvents. Examples of suitable water-miscible solvents are primary or secondary mono- or polyalcohols having 1 to about 6 C atoms, such as methanol, ethanol, propanol, isopropanol, n-butanol, isobutanol, pentanol, hexanol, cyclohexanol or glycerol. Likewise suitable as water-miscible solvents are low molecular weight ketones such as acetone or methyl ethyl ketone, or ether alcohols such as diethylene glycol or triethylglycol. Likewise suitable in the context of the present invention are solvents which are immiscible with water or miscible with water only to a small extent. Examples of these include ethers such as diethyl ether, dioxane or tetrahydrofuran, and also optionally substituted aliphatic solvents, including, for example, the higher homologs of the abovementioned alcohols and ketones, and also paraffinic hydrocarbons.

The aforementioned solvents may be used individually or as a mixture of two or more of the stated solvents. In one preferred embodiment of the present invention, the solvent used is water, optionally in a mixture with one or more of the aforementioned, preferably water-soluble, solvents. If a solvent that comprises water and a water-immiscible solvent is to be used in the context of the present invention, then the solvent may comprise, for example, an emulsifier, in order to permit a substantially stable W/O emulsion or an O/W emulsion. A purely aqueous solution is preferred.

If the preparation of the invention comprises a mixture of water and a further, water-miscible, solvent, then the proportion of water in such a mixture is preferably at least about 30% by weight or more, as for example at least about 40% or at least about 50% by weight. In one particularly preferred embodiment of the present invention, the water fraction is at least about 75% by weight. Examples of suitable combinations of water with water-miscible solvents are water/methanol, water/ethanol, water/propanol or water/isopropanol. Preferred in the context of the present invention is a mixture of water and ethanol where the water fraction is preferably greater than about 75% by weight, and for example greater than about 80% or about 85%, by weight.

In one preferred embodiment of the present invention, the preparation of the invention comprises at least one solvent which has a water fraction of at least about 50% by weight. It is particularly preferred to use water exclusively as solvent.

The at least one amine-containing or amide-containing alcohol used in the preparation of the invention preferably comprises one or more alkanolamines, alkanolamides and/or hyperbranched polyetheramine polyols.

Suitable amine-containing alcohols are primary, secondary or tertiary alkylamine compounds whose alkyl radical contains at least one, preferably two or more, hydroxyl group(s). The hydroxyl-containing alkylamine compounds may have identical or different linear or cyclic alkyl radicals with 1 to 8, preferably 1 to 6, carbon atoms. Particularly preferred are mono-, di- or tri-C₁-C₆ alkanolamines such as, for example, triethanolamine, tripropanolamine, triisopropanolamine, tributanolamine, diethanolamine, dipropanolamine, diisopropanolamine, dibutanolamine and/or monoethanolamine. Of these, triethanolamine is particularly preferred. Additionally preferred amine-containing alcohols are primary, secondary or tertiary amines of sugar alcohols such as, for example, mannitol, isomalt, lactitol, sorbitol (or glucitol) and xylitol, threitol, erythritol, and arabitol, the radicals R¹ and R² of the amino group NR¹R² that is attached to the sugar radical being identical or different and being H, C₁-C₄ alkyl, more particularly methyl and/or ethyl.

Examples of suitable representatives of this kind include N-methylglucamine, N,N-dimethylglucamine, N-ethylglucamine, etc. Suitable amide-containing alcohols are primary, secondary or tertiary alkylamide compounds whose alkyl radical contains at least one, preferably two or more, hydroxyl group(s). The hydroxyl-containing alkylamide compounds may have identical or different linear or cyclic alkyl radicals having 1 to 8, preferably 1 to 6, carbon atoms.

Particularly preferred are alkanolamides, examples being mono-, di- or tri-C₁-C₆ alkanolamides. Additionally preferred amine-containing alcohols are primary, secondary or tertiary amines of sugar alcohols such as, for example, mannitol, isomalt, lactitol, sorbitol (or glucitol) and xylitol, threitol, erythritol, and arabitol, the radicals R¹ and R² of the amino group NR¹R² that is attached to the sugar radical being identical or different and being H, C₁-C₄ alkyl, more particularly methyl and/or ethyl.

Examples of suitable representatives of this kind include gluconamides.

In accordance with one preferred embodiment, the preparation of the invention comprises as amine-containing alcohol (C) at least one high-functionality hyperbranched polyetheramine polyol.

A high-functionality hyperbranched polyetheramine polyol means a product which as well as the ether groups and the amino groups that form the polymer scaffold also has, terminally or laterally, at least three, preferably at least six, more preferably at least ten functional groups. The functional groups are OH groups. There is in principle no upper limit on the number of terminal or lateral functional groups, although products with a very large number of functional groups may exhibit unwanted properties, such as high viscosity or poor solubility, for example. The high-functionality polyetheramine polyols used in accordance with the invention usually have not more than 500 terminal or lateral functional groups, preferably not more than 100 terminal or lateral functional groups. The feature “hyperbranched” means in accordance with the invention that the degree of branching, DB, of the compounds in question, defined as

$$DB ( \% ) = \frac{T + Z}{T + Z + L} \times 100 ,$$

where T denotes the average number of terminally attached monomer units, Z the average number of the branch-forming monomer units, and L the average number of linearly attached monomer units in the macromolecules of the compounds in question, is 10% to 95%, preferably 25% to 90%, and more preferably 30% to 80%.

In the degree of branching thus defined, the nondendrimeric hyperbranched polymers differ from the dendrimeric polymers. The polymers are dendrimeric when their degree of branching, DB, is 99% to 100%. Accordingly, a dendrimer has the maximum possible number of branching sites, which can be achieved only by means of a highly symmetric construction. With regard to the definition of the degree of branching, see also H. Frey et al., Acta Polym. 1997, 48, 30.

Hyperbranched polymers for the purposes of this invention, then, are substantially noncrosslinked macromolecules which are structurally nonuniform. They may have a construction analogous with that of dendrimers, starting from a central molecule, but with a nonuniform branch chain length. They may also be constructed linearly with functional lateral branches, or may have linear and branched moieties. With regard to the definition of dendrimeric and hyperbranched polymers, see also P. J. Flory, J. Am. Chem. Soc. 1952, 74, 2718 and H. Frey et al., Chem. Eur. J. 2000, 6, No. 14, 2499. Further details on hyperbranched polymers and their synthesis can be found in, for example, J.M.S.-Rev. Macromol. Chem. Phys., C37(3), 555-579 (1997) and in the literature cited therein.

Polyetheramine polyols per se are known. The preparation of these polymers is described in, for example, U.S. Pat. No. 2,178,173, U.S. Pat. No. 2,290,415, U.S. Pat. No. 2,407,895, and DE 40 03 243.

The preparation of the high-functionality hyperbranched polyetheramine polyols used in accordance with the invention is described more particularly in WO 09/047,269.

The high-functionality highly branched polyetheramine polyols formed by the process described in WO 2009/047269 A2 are terminated with hydroxyl groups after the reaction, i.e., without further modification.

The OH number of the polyetheramine polyols used in accordance with the invention is usually 100 mg KOH/g or more, preferably 150 mg KOH/g or more.

The weight-average molar weight M_{w} of the polyetheramine polyols used in accordance with the invention is usually between 1000 and 500 000, preferably from 2000 to 300 000 g/mol, and the number-average molar weight Mₙ between 500 and 50 000, preferably between 1000 and 40 000 g/mol, as measured by means of gel permeation chromatography using hexafluoroisopropanol as mobile phase and polymethyl methacrylate (PMMA) as standard.

The high-functionality highly branched or hyperbranched polyetheramine polyols used in accordance with the invention generally have a glass transition temperature of less than 50° C., preferably less than 30° C., and more preferably less than 10° C.

The preparation used in accordance with the invention is acidic. It generally has a pH of from 0.5 to 6, with the choice of narrower pH ranges being possible in accordance with the substrate and mode of application and also with the time during which the surface is exposed to the preparation. By way of example the pH is adjusted preferably to the range from 2 to 4 for the purpose of treating aluminum surfaces and preferably to the range from 1 to 5 in the case where zinc or galvanized steel is being treated.

The pH of the preparation may be controlled on the one hand through the nature and concentration of the COOH-containing polymers or copolymers and, accordingly, comes about automatically. In this context it should be borne in mind that as a result of preparation the COOH groups in the polymer may have been fully or partly neutralized.

However, the preparation may optionally further comprise at least one organic or inorganic acid and/or corresponding salts (D) thereof. Examples of suitable acids (D) comprise phosphorus-, sulfur- or nitrogen-containing acids such as phosphoric acid, phosphonic acid, sulfuric acid, sulfonic acids such as methanesulfonic acid, amidosulfonic acid, p-toluenesulfonic acid, m-nitrobenzenesulfonic acid, and derivatives thereof, nitric acid, hydrochloric acid, formic acid, oxalic acid, lactic acid or acetic acid and their corresponding alkali metal, alkaline earth metal, transition metal (especially Zn, Zr Ti) or ammonium salts. The acid is preferably selected from the group consisting of HNO₃, H₂SO₄, H₃PO₄, formic acid, acetic acid, oxalic acid, and lactic acid. Particular preference is given to H₃PO₄ and/or HNO₃. Especially preferred are H₃PO₄ and its salts. It will be appreciated that mixtures of different acids can also be used.

Examples of phosphonic acids comprise 1-hydroxyethane-1,1-diphosphonic acid (HEDP), 2-phosphonobutane-1,2,4-tricarboxylic acid (PBTC), aminotri(methylene-phosphonic acid) (ATMP), ethylenediaminetetra(methylenephosphonic acid) (EDTMP) or diethylenetriaminepenta(methylenephosphonic acid) (DTPMP).

The nature and concentration of the acid (D) in the preparation is determined by the skilled person in accordance with the desired end application and pH. Generally speaking, a concentration which has proven appropriate is that from 0.01 g/l to 30 g/l, preferably from 0.05 g/l to 20 g/l and more preferably from 0.1 g/l to 10 g/l.

The preparation of the invention may also comprise, optionally, further components (E) beyond the specified components (A) to (D).

The components (E) present optionally may be, for example, transition metal ions and transition metal compounds, examples being those of Ce, Ni, Co, V, Fe, Zn, Zr, Mn, Mo, W, Ti, Zr, Hf, Bi and/or of the lanthanides. They may also be compounds of main group elements, such as Si, Ca, Mg and/or Al, for example. The compounds can be used for example in the form of salts or of the respective aqua complexes. They may also, however, be complexes with other ligands, such as oxometallates such as MoO₄²⁻ or WO₄²⁻, lactates or oxalates, for example. It is also possible, moreover, to use complexes with typical chelate-forming ligands such as ethylenediaminetetraacetic acid (EDTA), diethylenetriaminepentaacetic acid (DTPA), hydroxyethylethylenediaminetriacetic acid (HEDTA), nitrilotriacetic acid (NTA) or methylglycinediacetic acid (MGDA).

Further optional components (E) comprise surface-active compounds, corrosion inhibitors or typical electroplating auxiliaries. The skilled person makes an appropriate selection from among the optional components that are possible in principle, with respect also to their amounts, in accordance with the desired application. Examples of particularly preferred corrosion inhibitors which can be used in combination with the itaconic acid polymers comprise benzotriazole and/or tolyltriazole.

For the purpose of fine tuning its properties the preparation may also comprise further water-soluble polymers as additional components. Examples of such polymers comprise in particular polymers comprising carboxylate groups which merely do not correspond to the above definition of the composition of the polymer (A). Examples that may be mentioned include poly(meth)acrylic acids and also copolymers of (meth)acrylic acid with other monomers containing acid groups, such as maleic acid, fumaric acid, crotonic acid or vinylacetic acid, for example. The amount of such additional (co)polymers is determined by the skilled person in accordance with the desired properties of the passivating layer. The amount in general, however, should not exceed 30% by weight, preferably 20% by weight, and more preferably 10% by weight, based on the amount of all the polymers used.

The passivation in question is preferably a substantially chromium-free passivation. This is intended to denote that small amounts, at best, of chromium compounds could be added in order to fine-tune the properties of the passivating layer. The amount should not exceed 2%, preferably 1%, and more preferably 0.5% by weight of chromium, based on all constituents of the preparation of the invention. If chromium compounds are to be employed then it is preferably Cr(III) compounds that should be employed. In each case, however, the Cr(VI) content should be kept so low that the amount of Cr(VI) on the passivated metal does not exceed 1 mg/m².

With particular preference the passivation is a chromium-free passivation; in other words, the preparation employed contains no Cr compounds at all. The expression “chromium-free”, however, does not rule out the indirect and per se unintended entrainment of small amounts of chromium into the process. Indeed, if the preparation of the invention is used to passivate alloys which comprise chromium as an alloying constituent, Cr-containing steel for example, it is always within the bounds of possibility for small amounts of chromium in the metal to be treated to be dissolved by the preparation used for the process and, accordingly, to pass into the preparation unintentionally per se. Even in the case where such metals are used, with the resultant consequences, the process should still be regarded as “chromium-free”. With particular preference, moreover, it is a fluorine-free passivation.

The concentration of the polymers (A) in the preparation of the invention is determined by the skilled person in accordance with the desired application. For example, the thickness of the passivating layer is dependent on the selected technology, but may also be dependent on the viscosity of the preparation that is used for passivating. Generally speaking, a concentration which has been found appropriate is from 0.01 g/l to 500 g/l, preferably 0.5 g/l to 200 g/l, and more preferably 10 g/l to 150 g/l. The concentrations stated are based on the preparation in its ready-to-use form.

The concentration of the nitrogen-containing alcohol (C) in the preparation of the invention is dependent on the concentration of the itaconic acid homopolymer or copolymer (A) and amounts in general to 0.5% to 30%, preferably 1% to 20%, more preferably 1% to 15%, by weight, based on the itaconic acid homopolymer or copolymer (A).

The amount of water or another solvent (B) is dependent on whether the preparation of the invention is a ready-to-use preparation or a concentrate, and also on the particular end use. In principle, the amount is a product of the concentrations of the individual components as indicated for the ready-to-use form.

In accordance with one preferred embodiment, acidic aqueous preparations of the invention comprise 1% to 20% by weight of itaconic acid homopolymer or copolymer (A), 0.1% to 2% by weight of the nitrogen-containing alcohol (C), and optionally 0.1% to 2% by weight of an acid (D), based in each case on solids.

The aforementioned embodiment can be combined with other configurations.

Preference is given to corresponding acidic aqueous preparations of the invention comprising as component (A) copolymers of itaconic acid and acrylic acid, preferably 35% to 65% by weight itaconic acid and 35% to 65% by weight acrylic acid, and as component (C) at least one amine-containing or amide-containing alcohol, more particularly mono-, di-, and tri-C₁-C₆ alkanolamines and/or amides, primary, secondary or tertiary amines and/or amides of sugar alcohols, and/or hyperbranched, high-functionality polyetheramine polyols, with the exception of preparations comprising as component (A) copolymers (A) formed from (a1) 0.1% to 50% by weight itaconic acid, and (a2) 50% to 99.9% by weight (meth)acrylic acid, and as component (C) mono-, di- and/or triethanolamine.

Additionally preferred are corresponding acidic aqueous preparations of the invention comprising as component (A) terpolymers of itaconic acid, acrylic acid, and vinylphosphonic acid, preferably of 20% to 50% by weight itaconic acid, 30% to 50% by weight acrylic acid, and 1% to 30% by weight vinylphosphonic acid, and, as component (C), at least one amine-containing or amide-containing alcohol, more particularly mono-, di-, and tri-C₁-C₆ alkanolamines and/or -amides, primary, secondary or tertiary amines, and/or amides of sugar alcohols, and/or hyperbranched, high-functionality polyetheramine polyols.

Particularly preferred are aforesaid preparations of the invention in which component (C) is selected from the group containing triethanolamine, tripropanolamine, triisopropanolamine, tributanolamine, diethanolamine, dipropanolamine, diisopropanolamine, dibutanolamine, monoethanolamine, N-methylglucamine, N,N-dimethylglucamine, N-ethylglucamine, gluconamide, and hyperbranched, high-functionality polyetheramine polyol. A special preference among these is given to triethanolamine, N-methylglucamine, gluconamide and/or hyperbranched, high-functionality polyetheramine polyol.

The preparations of the invention can be used in all applications for passivating metallic surfaces and for forming passivating layers on metals. Reference is made in this context to the introductory definition of the term “passivating layer”. The preparations of the invention are suitable more particularly for chromium-free passivation.

Any metallic surfaces can be treated, and in particular passivated, by means of the polymers of the invention. Preferably, however, the surfaces are those of Zn, Zn alloys, Al or Al alloys. These may be the surfaces of structures or workpieces composed entirely of said metals and/or alloys. Alternatively they may be the surfaces of structures coated with Zn, Zn alloys, Al or Al alloys, it being possible for the structures to be composed of other materials: for example, other metals, alloys, polymers or composites. The surface in question may in particular be that of galvanized iron or steel. In one particular embodiment of the method it is the surface of a strip metal, in particular electrolytically galvanized or hot-dip-galvanized steel. Likewise part of the method of the invention is the passivation of piece goods (drum product, rack product, etc.).

Zn alloys or Al alloys are known to the skilled worker. The skilled worker selects the type and amount of alloying constituents in accordance with the desired end application. Typical constituents of zinc alloys for hot-dip processes comprise, in particular, Al, Pb, Si, Mg, Sn, Cu or Cd. Typical alloying components in Zn alloys which are deposited electrolytically are Ni, Fe, Co and Mn. Typical constituents of aluminum alloys comprise, in particular, Mg, Mn, Si, Zn, Cr, Zr, Cu or Ti. The alloys in question can also be Zn/Mg or Al/Zn alloys in which Zn and Mg or else Al and Zn are present in approximately equal amounts. Steel coated with such alloys is available commercially.

In the method of the invention for passivating metallic surfaces the surface of the metal is treated with the preparation of the invention by means, for example, of spraying, dipping or rolling. After a dipping operation excess treatment solution can be removed from the workpiece by allowing it to drip dry; in the case of metal sheets, metal foils or the like excess treatment solution can alternatively be removed by squeezing off or squeegeeing, for example. In the course of the treatment parts at least of the polymer used and also further components of the preparation are chemisorbed by the surface of the metal, so that a solid bond comes about between the surface and the components. Treatment with the preparation of the invention takes place generally at room temperature or above, although this is not intended to rule out the possibility of lower temperatures in principle. As a general rule the treatment takes place at from 20 to 90° C., preferably 20 to 80° C., and more preferably 20 to 60° C. For that purpose the bath containing the preparation of the invention can be heated, although an elevated temperature may also come about automatically, by the immersion of hot metal into the bath.

It is possible to rinse the surface, after treatment, with a cleaning liquid, in particular with water, in order to remove residues of the preparation of the invention from the surface.

The treatment may alternatively be what is called a no-rinse operation, in which the preparation of the invention is dried directly in a drying oven immediately following its application, without rinsing.

The treatment of the metal surface with the preparation of the invention and/or, if used, the crosslinker can take place discontinuously or, preferably, continuously. A continuous process is particularly suitable for treating strip metals, i.e., coil coating. The metal strip is run through a trough or a spraying apparatus with the preparation of the invention and also, optionally, through further pretreatment or posttreatment stations.

The treatment time is specified by the skilled person in accordance with the desired properties of the layer, the respective preparation of the invention, and the technical boundary conditions. It may be considerably less than one second or may be two or more minutes. In the case of the continuous method it has proven particularly appropriate to contact the surface with the preparation of the invention for a time of from 1 to 60 s.

Following the treatment the solvent used is removed. It can be removed at room temperature by simple evaporation in air at room temperature.

Alternatively the removal of the solvent may be assisted by means of suitable auxiliary means, such as by heating and/or passing streams of gas, particularly streams of air, over the treated surface. The evaporation of the solvent can be assisted, for example, by means of IR emitters, or else, for example, by drying in a drying tunnel. For the purpose of drying a temperature which has proven appropriate is that from 30° C. to 180° C., preferably from 40° C. to 100° C., and more preferably from 40° C. to 80° C. This refers to the temperature on the metal surface (peak metal temperature); it may be necessary to set the dryer temperature at a higher level, which is chosen appropriately by the skilled person.

The method of the invention may optionally comprise one or more pretreatment steps. For example, prior to passivation, the metallic surface can be cleaned, in order for example to remove greases or oils. It is also possible to pickle the surface prior to passivation, in order to remove oxide deposits, scale, temporary corrosion protection, and the like. It is additionally necessary to rinse the surface, optionally with water also, after and between such pretreatment steps, and to remove the residues of rinsing solutions or pickling solutions.

The passivating layer may additionally be crosslinked. For this purpose it is possible, for example, to admix a crosslinker to the preparation of the invention, provided said crosslinker does not react while still in the preparation. An alternative is first to treat the metal with the preparation of the invention and thereafter to treat the layer with a suitable crosslinker—for example, to spray it with the solution of a crosslinker.

Suitable crosslinkers should be water-soluble or at least soluble in the aforementioned aqueous solvent mixture. Examples of suitable crosslinkers comprise in particular those which have at least two crosslinking groups selected from the group of azirane groups, oxirane groups or thiirane groups. Further details of suitable crosslinkers are disclosed in application WO 2005/042801 A1, hereby expressly incorporated by reference.

The method of the invention makes it possible to obtain a passivating layer on a metallic surface, such a layer being likewise provided by the invention. The precise structure and composition of the passivating layer are unknown. However, in addition to the customary amorphous oxides of aluminum or of zinc and also, optionally, of other metals, said layer comprises the reaction products of the polymer and also, optionally, of the crosslinker and/or of further components of the preparation of the invention. The composition of the passivating layer is generally not homogeneous; rather, the components appear to exhibit concentration gradients.

The thickness of the passivating layer of the invention is adjusted by the skilled person in accordance with the desired properties of the layer. In general the thickness is from 0.01 to 3 μm, preferably from 0.02 to 1 μm, very preferably from 0.03 to 0.2 μm. The thickness can be influenced, for example, by way of the nature and amount of the components applied, and also by way of the exposure time. In addition, it is possible to use technical parameters of the method to influence the thickness: by using rollers or squeegees to remove treatment solution applied in excess, for example.

The thickness of the layer is determined by differential weighing before and after exposure of the metal surface to the preparation of the invention, on the assumption that the layer has a specific density of 1 kg/l. In the text below, “layer thickness” always refers to a variable determined in this way, irrespective of the actual specific density of the layer.

The present specification further provides a metallic surface which comprises the passivating layer of the invention. The passivating layer is applied directly on the actual metal surface. In one preferred embodiment the metal surface in question is that of a strip metal of steel which comprises a coating of Zn or of a Zn alloy and on which a pretreatment layer or passivating layer of the invention has been applied.

The metallic surface of the invention with its passivating layer may in principle be recoated in a known manner with one or more paint layers (primer, topcoat). Typical paints, their composition, and typical layer sequences in the case of two or more paint layers are known in principle to the skilled person.

The preparation of the invention can be employed at different processing stages. It can be undertaken, for example, at the premises of a steel maker. In this case a steel strip can be galvanized in a continuous process and immediately after having been galvanized can be passivated by treatment with the preparation of the invention. Passivation at this stage is frequently referred to by the skilled worker as “posttreatment”.

The passivation in question may be only temporary, serving to protect against corrosion in the course of storage and transport and/or during further process steps, but removed again before the permanent corrosion protection is applied. The acidic polymers can be removed from the surface again by cleaning with aqueous alkaline solutions.

Alternatively the treatment may be a permanent corrosion protection treatment, which remains on the strip or on the fully-formed workpiece and is provided with additional paint coats. Passivation at this stage is frequently referred to by the skilled worker as “pretreatment”.

The preparation of the invention achieves much better corrosion protection, especially in pretreatment, than when using corresponding prior-art preparations.

The examples which follow are intended to illustrate the invention in more detail:

### Measurement Methods:

The K values were measured by the method of H. Fikentscher, Cellulose-Chemie, vol. 13, pp. 58-64 and 71-74 (1932) in 1% strength by weight aqueous solution at 25° C. and a pH of 7.

The polyetheramine polyols were analyzed by gel permeation chromatography using a refractometer as detector. The mobile phase used was hexafluoroisopropanol (HFIP), while the standard used for determining the molecular weight was polymethyl methacrylate (PMMA).

The OH number was determined in accordance with DIN 53240, Part 2.

### Preparation of Inventively Used Hyperbranched Polyetheramine Polyols (C)

(C.1) A four-neck flask equipped with stirrer, distillation bridge, gas introduction tube, and internal thermometer, was charged with 2000 g of triethanolamine (TEA) and also 13.5 g of hypophosphorous acid in the form of a 50% strength aqueous solution, and the mixture was heated to 230° C. At around 220° C., the formation of condensate slowly commenced. The reaction mixture was stirred at 230° C. for 4 hours, the condensate formed in the reaction being removed by the distillation bridge by means of a moderate N₂ stream as stripping gas. Toward the end of the indicated reaction time, residual condensate was removed under a subatmospheric pressure of 500 mbar. When the desired conversion had been reached, the batch was cooled to 140° C. and the pressure was reduced slowly and in stages to 100 mbar in order to remove remaining volatile fractions. The product mixture was subsequently cooled to room temperature. Mw: 6500, Mn: 3800, OH number of product (mg KOH/g) according to DIN 53240, Part 2: 512

### Preparation of Inventively Used Polymers (A)

### (A.1) Terpolymer of Acrylic Acid, Itaconic Acid, and Vinylphosphonic Acid

A 6 I reactor vessel fitted with anchor stirrer, temperature control, nitrogen inlet, and 2 feed ports is charged with 85.3 g of vinylphosphonic acid (95% form), 292.7 g of itaconic acid, and 531.3 g of deionized water. The initial charge is gassed with nitrogen for 15 minutes and heated to 98° C. under a nitrogen atmosphere. Subsequently, over the course of 5 hours, 324.3 g of acrylic acid in 324.3 g of deionized water are added, and, over the course of 6 hours, 41.9 g of sodium peroxodisulfate in 250 g of deionized water. This is followed by stirring at 98° C. for 2 hours more. The product is a pale yellow, clear polymer solution having a solids content of 40.2% and a K value of 23.2 (1% strength in deionized water).

### Batching of the Inventive Preparations

The inventively used components were dissolved in the aqueous polymer solution obtained, and this preparation was homogenized and introduced into a deposition bath.

### Example 1

Preparation composed of 9.6% by weight (based on solids) of terpolymer (A.1), 0.4% by weight of hyperbranched polyetheramine polyol (C.1) in water

### Example 2

Preparation composed of 9.3% by weight (based on solids) of terpolymer (A.1), 0.4% by weight of N-methylglucamine, 0.4% by weight of H₃PO₄ in water

### Example 3

Preparation composed of 8.5% by weight (based on solids) of terpolymer (A.1), 0.8% by weight of triethanolamine, 0.7% by weight of H₃PO₄, 0.2% by weight of magnesium phosphate in water

### Comparative Example 1

Preparation composed of 10% by weight (based on solids) of terpolymer (A.1) in water

### Comparative Example 2

Preparation composed of 10% by weight (based on solids) of terpolymer (V2) prepared as per WO 2004/074372, Example 2

### Comparative Example 3

### Not Disclosed in WO 2004/074372

Preparation composed of 9.6% by weight (based on solids) of terpolymer (V2), 0.4% by weight of hyperbranched polyetheramine polyol (C.1) in water

### Comparative Example 4

### Not Disclosed in WO 2004/074372

Preparation composed of 8.5% by weight (based on solids) of terpolymer (V2), 0.8% by weight of triethanolamine, 0.7% by weight of H₃PO₄, 0.2% by weight of magnesium phosphate in water

### Passivation of Metallic Surfaces

### Metallic Surface and its Pretreatment:

The tests were carried out using test panels made of hot-dip-galvanized steel (105×390×0.75 mm; 20 μm zinc add-on, Gardobond OE HDG 3, from Chemetall).

### Cleaning (Step 1):

The panels were first degreased with ethanol and ethyl acetate and then immersed into an alkaline cleaning solution (e.g., Ridoline C72, from Henkel, 4.3 g/l at 60° C. for 1 minute), immediately rinsed with deionized water, and then dried using nitrogen.

### Application of the Pretreatment Layer (Step 2):

The cleaned panels were immersed into the respective preparation (see Table 1) for in each case 2 to 3 seconds at room temperature, squeezed off with a system of rolls, and dried in a drying oven at 160° C. for 15 to 20 seconds. The peak metal temperature in the course of this drying did not exceed 50° C. 2 panels were coated in each case.

### Application of Primer and Topcoat (Step 3):

The panels with pretreatment layer, and also a commercially available panel pretreated with Gardo TP10475 (from Chemetall, Cr-free, F-containing), which is used as a reference panel, were coated using a wire doctor with the respective primer (see Table 1) and baked in an oven in accordance with manufacturer specifications, after which they were briefly immersed in deionized water and dried using compressed air. The respective topcoat (see Table 1) was then applied likewise using a wire doctor in accordance with manufacturer specifications, and baked in an oven, after which the panels were briefly immersed in deionized water and dried vertically.

### Test Methods

### Salt Spray Test:

The result of a salt spray test in accordance with DIN 50021 is used as a measure of the corrosion inhibition effect. The salt spray test was carried out with the fully coated panels (steps 1 to 3) by means of a well-defined central vertical scribe mark, 0.3 mm wide and 11 cm long (through the paint coats and through the Zn coating); the storage time was 6 weeks. The results of the tests are collated in Table 1. The sub-film corrosion is the average half-side spreading of the original scribe mark. The average value was formed from the panels investigated.

### T-Bend Test:

The T-bend test was carried out in accordance with DIN EN ISO 1519:2003 using the fully coated panels (steps 1-3). The test result is collated in Table 1 and indicates the minimum distances possible between the two sides of the bent panel such that no delamination phenomena are apparent. The values are listed in relative units, standardized for the panels with the commercially available pretreatment Gardo TP10475, from Chemetall. The average value was formed from the panels investigated.

### Tape Delamination Test:

The tape test was carried out in accordance with DIN EN ISO 1519:2003 on the fully coated panels (steps 1-3). The test result is collated in Table 1 and indicates the minimum distances possible between the two sides of the bent panel such that no tape delamination phenomena are apparent at the bent edge. The values are listed in relative units, standardized for the panels with the commercially available pretreatment Gardo TP10475, from Chemetall.

The average value was formed from the panels investigated.

TABLE 1
Results of the tests on the coated panels

| | | | Sub-film corrosion | T-bend test | Tape test |
|---|---|---|---|---|---|
| Pretreatment | Primer | Topcoat | (mm) | (rel. units) | (rel. units) |
| Example 1 | Coiltec ® Universal P CF (BASF) | Polyceram ® Plus P, white (BASF) | 0.2 | 100 | 45 |
| Example 2 | Coiltec ® Universal P CF (BASF) | Polyceram ® Plus P, white (BASF) | 0.3 | 100 | 55 |
| Example 3 | Coiltec ® Universal P CF (BASF) | Polyceram ® Plus P, white (BASF) | 0.2 | 95 | 45 |
| Comparative | Coiltec ® Universal P CF (BASF) | Polyceram ® Plus P, white (BASF) | 4.3 | 95 | 60 |
| example 1 | | | | | |
| Comparative | Coiltec ® Universal P CF (BASF) | Polyceram ® Plus P, white (BASF) | 95% of total | 100 | 100 |
| example 2 | | | coating detached | | |
| Comparative | Coiltec ® Universal P CF (BASF) | Polyceram ® Plus P, white (BASF) | 95% of total | 100 | 130 |
| example 3 | | | coating detached | | |
| Comparative | Coiltec ® Universal P CF (BASF) | Polyceram ® Plus P, white (BASF) | 95% of total | 100 | 100 |
| example 4 | | | coating detached | | |
| Gardo TP 10475 | Coiltec ® Universal P CF (BASF) | Polyceram ® Plus P, white (BASF) | 0.8 | 100 | 100 |
| (Chemetall), | | | | | |
| fluorine-containing | | | | | |
| Example 1 | Coiltec ® Top P CF Universal (BASF) | Polyceram ® Plus P, white (BASF) | 0.0 | 100 | 60 |
| Example 2 | Coiltec ® Top P CF Universal (BASF) | Polyceram ® Plus P, white (BASF) | 0.0 | 100 | 60 |
| Example 3 | Coiltec ® Top P CF Universal (BASF) | Polyceram ® Plus P, white (BASF) | 0.0 | 95 | 65 |
| Comparative | Coiltec ® Top P CF Universal (BASF) | Polyceram ® Plus P, white (BASF) | 0.1 | 100 | 80 |
| example 1 | | | | | |
| Gardo TP 10475 | Coiltec ® Top P CF Universal (BASF) | Polyceram ® Plus P, white (BASF) | 0.3 | 100 | 100 |
| (Chemetall), | | | | | |
| fluorine-containing | | | | | |

The test results show (Table 1) that the preparation of the invention achieves a significantly better corrosion protection and very good mechanical properties than when using corresponding prior-art preparations.

1. A preparation for passivating metallic surfaces, comprising
a) at least one itaconic acid homopolymer or copolymer (A), the polymer being synthesized from the following monomeric units:
(a1) 0.1% to 100% by weight of itaconic acid,
(a2) 0% to 99.9% by weight of at least one monoethylenically unsaturated monocarboxylic acid, and
(a3) 0% to 40% by weight of at least one further ethylenically unsaturated monomer, which is different from (a1) and (a2) and contains acidic groups, and/or
(a4) 0% to 75% by weight of at least one further ethylenically unsaturated monomer, which is different from (a1), (a2) and (a3),
the amount being based in each case on the total amount of all the monomers (a1) to (a4) copolymerized in the copolymer, and the amounts adding up to 100% by weight;
b) water and/or another solvent suitable for dissolving, dispersing, suspending or emulsifying polymer (A), as component (B); and
c) at least one amine- or amide-containing alcohol (C),
with the exception of a preparation comprising at least one copolymer (A) of (a1) 0.1% to 50% by weight itaconic acid and (a2) 50% to 99.9% by weight (meth)acrylic acid, component (B), and mono-, di- and/or triethanolamine as component (C).

2. The preparation according to claim 1, comprising, further to components (A), (B) and (C), at least one inorganic or organic acid and/or corresponding salts thereof, as component (D).

3. The preparation according to claim 1, wherein the amine- or amide-containing alcohol (C) is at least one primary, secondary or tertiary alkylamine or amide compound whose alkyl radical contains at least one, preferably two or more, hydroxyl group(s), and/or is at least one hyperbranched polyetheramine polyol.

4. The preparation according to claim 1, wherein the amine- or amide-containing alcohol (C) is selected from the group containing mono-, di-, and tri-C₁-C₆-alkanolamines, mono-, di-, and tri-C₁-C₆-alkanolamides, primary, secondary or tertiary amines of sugar alcohols, primary, secondary or tertiary amides of sugar alcohols, and hyperbranched polyetheramine polyols.

5. The preparation according to claim 1, wherein the amount of itaconic acid (a1) is 10% to 70% by weight and the amount of monoethylenically unsaturated monocarboxylic acids (a2) is 30% to 90% by weight.

6. The preparation according to claim 1, wherein the amount of monomer (a3) is 0.1% to 40% by weight.

7. The preparation according to claim 1, wherein the itaconic acid copolymer (A) is a copolymer comprising monomer units of itaconic acid (a1) and acrylic acid (a2) or a terpolymer comprising monomer units of itaconic acid (a1), acrylic acid (a2), and vinylphosphonic acid (a3).

8. A method of producing a passivating layer on a metal surface, which comprises treating the metal surface with a preparation according to claim 1.

9. The method according to claim 8, wherein the metal surface is the surface of a strip metal.

10. The method according to claim 9, wherein the strip metal comprises electrolytically galvanized or hot dip galvanized steel.

11. The method according to claim 8, wherein the treatment is performed by means of a continuous process.

12. A passivating layer on a metallic surface, obtainable by a method according to claim 8.

13. A metallic surface comprising a passivating layer according to claim 12.

14. The metallic surface according to claim 13, wherein one or more paint coats applied one above another are further present on the passivating layer.
